(19) United States
(12) Patent Application Publication
(10) Pub. No.: US 2026/0253389 A1
(43) Pub. Date: Aug. 27, 2026

(54) TASK-AWARE SEMANTIC MAP

(71) Applicant: IUCF-HYU (Industry-University Cooperation Foundation Hanyang University), Seoul (KR)

(72) Inventors: Yoonseon OH, Seoul (KR); Daewon CHOI, Seoul (KR)

(73) Assignee: IUCF-HYU (Industry-University Cooperation Foundation Hanyang University), Seoul (KR)

(21) Appl. No.: 19/647,701

(22) Filed: Apr. 14, 2026

Related U.S. Application Data
(63) Continuation of application No. PCT/KR2025/021647, filed on Dec. 15, 2025.

(30) Foreign Application Priority Data
Dec. 31, 2024 (KR) 10-2024-0201911

(51) Int. Cl. G06V 10/70; B25J 9/16; G01C 21/00; G06V 10/25; G06V 10/26; G06V 10/762; G06V 20/64; G06V 20/70

(52) U.S. Cl. CPC G06V 10/768; B25J 9/1661; G01C 21/3807; G06V 10/25; G06V 10/26; G06V 10/762; G06V 20/64; G06V 20/70

(57) ABSTRACT

A task-aware semantic map is disclosed. A method for building a task-aware semantic map performed by a task-aware semantic map building system according to an embodiment may include allocating a task to each object based on context information of each object identified by a robot; and building the task-aware semantic map by integrating said each object and the task allocated to said each object.

### CROSS-REFERENCE TO RELATED APPLICATIONS

This U.S. non-provisional application is a continuation of PCT International Application No. PCT/KR2025/021647, with an international filing date of Dec. 15, 2025, which claims priority to Korean Patent Application No. 10-2024-0201911, filed in the Korean Intellectual Property Office on Dec. 31, 2024. The disclosures of the above applications are incorporated herein by reference in their entirety.

### BACKGROUND

### 1. Field of the Invention

The following description relates to a technology in which a robot autonomously grasps the context of an object and independently generates an appropriate task even without specific human instructions.

### 2. Description of the Related Art

In the field of robot applications for performing tasks within a home, task planning is considered a very important issue. Due to the recent development of Large Language Models, research on task planning methods that effectively interpret human commands is being actively conducted. For example, many studies have been conducted on formulating plans based on specific and detailed commands such as “go to the kitchen and pick up an apple”.

However, in the future when home robots become more common, it may be very cumbersome to manually specify all the tasks that need to be performed every day. For example, if a house is messy, the robot should autonomously recognize this and start cleaning. In addition, it should be able to intelligently handle necessary tasks, such as setting the table at dinner time and running the vacuum cleaner if there is a lot of dust. Therefore, there is a demand for a technology that allows a robot to understand the environment and autonomously recognize and suggest tasks.

### SUMMARY

To resolve the above issues, a task-aware semantic map capable of identifying potential tasks in an environment and suggesting appropriate tasks suitable for the current situation can be provided.

A method for building a task-aware semantic map performed by a task-aware semantic map building system may include allocating a task to each object based on context information of each object identified by a robot; and integrating each object and the task allocated to each object to build the task-aware semantic map.

The allocating step may include receiving images of a specific environment captured from different viewpoints or from different positions and directions. The allocating step may include detecting each object from the received image of the specific environment, and allocating a mask, a label, and a bounding box to each detected object, and each object may be defined as a segmented entity. The allocating step may include selecting a region of interest of each detected object by applying a specific selection criterion, and the specific selection criterion may include at least one of a criterion for excluding a bounding box intersecting with an image boundary or a criterion for excluding a bounding box having a preset size or less. The allocating step may include allocating a specific task to the object in the selected region of interest. The allocating step may include predicting a task to be allocated to the object in the selected region of interest using a multi-modal large language model, and allocating the predicted task to the object in the selected region of interest.

The building step may include integrating segmented entities having the same label into an object entity. The building step may include generating a 3-dimensional (3D) point cloud during the process of integrating into the object entity. The building step may include performing clustering on the generated 3D point cloud. The building step may include identifying each object according to performing the clustering, and each identified object may be a set of 3D point clouds having a close distance and a similar label. The building step may include collecting tasks allocated to the same object, and calculating a task importance vector indicating a relative importance of each task through the collected tasks allocated to each object. The calculated task importance vector may determine a priority of a task to be processed by the robot for the corresponding object. The building step may include visualizing a result of the calculated task importance vector as a bar graph on the built task-aware semantic map.

The task-aware semantic map building system may include a task generation module for allocating a task to each object based on context information of each object identified by a robot; and a semantic fusion module for integrating each object and the task allocated to each object to build the task-aware semantic map.

The introduction of the task-aware semantic map provides several innovative effects compared to existing robot task planning methods. Whereas traditional methods heavily rely on explicit human instructions, the present invention improves the autonomy of a home service robot capable of independently recognizing tasks and designating priorities in a home environment. Regarding autonomous task identification and prioritization, the present invention uses a mapping that analyzes the context of objects within the environment and autonomously generates tasks. This eliminates the need for direct human labor, enabling the robot to operate more efficiently within a dynamically changing environment. Regarding contextual task suggestion, as one of the methods for designating task priorities, it can identify and execute tasks depending on the situation, such as when a house is messy. By integrating with Large Language Models (LLMs), nuances of human language and environmental context can be better understood, and the needs of the home can be responded to more sophisticatedly even without explicit commands. Regarding spatial task suggestion, the present invention improves the effectiveness of task completion by focusing on spatial information to determine high-priority areas that require immediate attention.

According to an embodiment of the present invention, the region of interest selection module can reduce the number of object candidates passed to a subsequent processing step by filtering bounding boxes intersecting with an image boundary or bounding boxes equal to or smaller than a preset size from among object detection results. Such a filtering process reduces the number of object candidates input to a multi-modal language model, thereby reducing the amount of inference computation performed by a processor of the robot system, and consequently provides a technical effect of shortening the processing time of the task allocation step.

In addition, the task allocation module crops an image around a bounding box corresponding to each object, generates a partial image including a preset pixel margin, and uses it as an input for the multi-modal language model. By using the object-centric partial image in this way, the size of input data can be reduced compared to a case of processing the entire image, thereby reducing the computational complexity of the vision encoder and the language model, and improving inference efficiency.

In addition, the semantic fusion module may convert segmented entities observed from different viewpoints into a 3D point cloud, and then perform clustering to integrate them into an object entity corresponding to the same object. Such a 3D-based object integration process reduces object information redundantly generated for the same object, and consequently provides an effect of reducing the size of data stored in the task-aware semantic map and reducing memory usage.

Furthermore, by integrating tasks allocated to the same object from various viewpoints into a task importance vector, the robot system can efficiently express a plurality of task candidates, thereby reducing the computational complexity of the task priority calculation process. The method of the present invention provides technical effects of reducing the computation amount of artificial intelligence (AI) inference operations performed in a robot processor, optimizing memory usage, and improving the real-time task planning performance of the robot system.

### BRIEF DESCRIPTION OF THE DRAWINGS

FIG. 1 is a diagram for explaining an operation of building a task-aware semantic map, according to an embodiment.

FIG. 2 is a diagram for explaining an operation of suggesting a task by situation, according to an embodiment.

FIG. 3 is a diagram for explaining an operation of successfully predicting a task by considering a state of an object in a task-aware semantic map, according to an embodiment.

FIG. 4 is an example for explaining a result of spatial-based task suggestion, according to an embodiment.

FIG. 5 is a block diagram for explaining a task-aware semantic map building system, according to an embodiment.

FIG. 6 is a flowchart for explaining a method for building a task-aware semantic map, according to an embodiment.

### DETAILED DESCRIPTION

Hereinafter, embodiments will be described in detail with reference to the accompanying drawings.

In the embodiments, an operation in which a robot autonomously grasps context information of an object even without specific human instructions and independently generates an appropriate task based on the grasped context information will be described. Accordingly, by providing a system capable of not only understanding the context of an object but also autonomously identifying tasks and designating priorities, a great improvement in efficiency, adaptability, and user convenience can be provided, thereby greatly advancing the field of home robotics.

A task-aware semantic map building system may identify an object and a related task in an image of a specific environment, and then integrate information acquired from various viewpoints to build a task-aware semantic map. In the embodiment, an operation in which a task-aware semantic map is built by a robot providing services within a home environment will be described as an example.

The task-aware semantic map is an advanced type of map that does not simply stop at identifying the location of an object, but also specifies tasks necessary to keep the home clean and organized. For example, if water is spilled on a desk, it updates that the desk needs to be wiped. The task-aware semantic map may be designed to allow the robot to suggest a task that can use a task goal.

The task-aware semantic map may be defined as a set of tuples.

$$M = ( {L}_{i} , \text{?} , {ϕ}_{i} \text{?} = 1$$

$$\text{?} \text{indicates text missing or illegible when filed}$$

Here, n objects exist in the environment. Each tuple (object entity) may include a label Lᵢ, and Sᵢ may be configured as a set of point clouds. A task importance vector φ∈R¹² may be used, and a j-th element of the vector indicates the importance of a j-th task.

The task-aware semantic map building system may include a task generation module and a semantic fusion module. The task-aware semantic map building system may allocate a task to each object based on context information of each object identified by the robot through the task generation module. The task-aware semantic map building system may integrate each object and the task allocated to each object to build the task-aware semantic map.

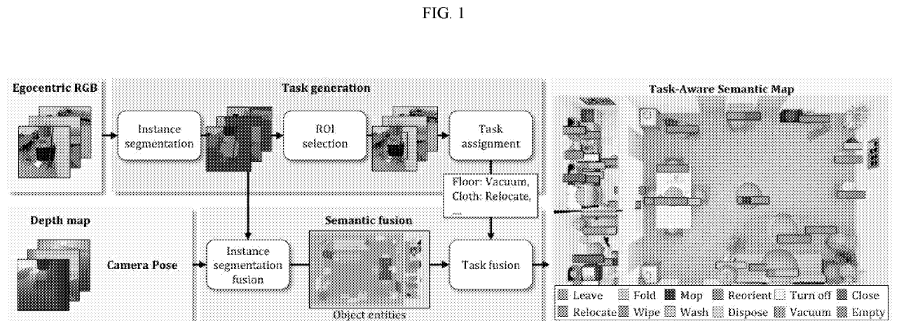

Referring to FIG. 1, the task generation module may use an egocentric RGB image as an input to associate each object present in the image with a task. The semantic fusion module uses inputs such as depth information and a camera pose, and may combine task generation results with object entities to generate the task-aware semantic map. On the right side, object entities are represented as scaled spheres, and a bar graph representing a task importance vector may be displayed on each sphere.

The task generation module serves to identify objects in the environment through instance segmentation, and allocate a potential task associated with each object. It can receive an RGB image, detect an object, grasp the context of the detected object, and allocate a task. The task generation module may include an instance segmentation module, a region of interest (ROI) selection module, and a task assignment module.

The instance segmentation module may detect each object from the image I received from the Egocentric RGB camera, and specify a label for each detected object. The instance segmentation module may define pixel-level locations and boundaries of objects. The instance segmentation module may allocate a mask Mᵢ, a label Lᵢ, and a bounding box B₁ to each detected object. Here, i represents an index of the object, and Bᵢ is a minimum bounding box including all pixels of Mᵢ. At this time, each object is defined as a segmented entity, and may be expressed as the following tuple:

$$\text{?} = ( \text{?} , {M}_{i} , {L}_{i} )$$

$$\text{?} \text{indicates text missing or illegible when filed}$$

Here, p^{c} represents the camera pose. Such a segmented entity can be used to allocate a task together with the bounding box.

The ROI selection module may select a region of interest of each object based on the size and location of the bounding box of the object acquired through the instance segmentation module. The ROI selection module may apply a specific selection criterion to select the region of interest of each detected object. In this case, the specific selection criterion may include at least one of a criterion for excluding a bounding box intersecting with an image boundary or a criterion for excluding a bounding box having a preset size or less. In other words, the ROI selection module can select a case where the bounding box does not overlap with the image boundary and has a sufficient size. Through this, the selected regions of interest are expressed as

$$( \text{?} , {M}_{i} , \text{?} , \text{?} = 1 ,$$

$$\text{?} \text{indicates text missing or illegible when filed}$$

where nR represents the total number of selected regions of interest.

The task allocation module may allocate a task tᵢ according to context for the selected region of interest. Accordingly, a task-allocated entity may be defined as

$$\text{?} = ( \text{?} , {L}_{i} , {B}_{i} , {t}_{i} ) .$$

$$\text{?} \text{indicates text missing or illegible when filed}$$

The task allocation module may use a multi-modal large language model to allocate a task. Similar to large language models, the multi-modal large language model is trained on extensive corpora and can infer common knowledge. Through this, an appropriate task can be allocated according to the context surrounding the object.

The task allocation module may crop image I around the bounding box Bᵢ to focus on object i with a margin of W pixels on each side to predict each task tᵢ. The cropped image may be input to the multi-modal large language model together with a prompt to obtain an output tᵢ. The task allocation module may design a prompt using an In-Context Learning technique that incorporates few-shot examples explaining the reason for selecting each task in a specific situational context. At this time, each task tᵢ is a single value, and may be selected from a task set T. The task set T refers to all possible tasks that the robot can perform, and includes Leave as it is, Relocate, Reorient, Wipe, Vacuum, Dispose, Fold, Turn-off, Wash, Close, and Empty.

The semantic fusion module is required to represent the task-allocated object on the map M and considers physical information. The semantic fusion module may fuse into a single entity in 3D based on 2D information of the object acquired through the instance segmentation module. When an object is observed from various viewpoints, it may generate segmented entities and task-allocated entities. The semantic fusion module may include an instance segmentation fusion module and a task fusion module.

The instance segmentation fusion module may identify segmented entities generated from the same object, and fuse the identified entities to generate object entities

$${E}_{k}^{obj} = ( {L}_{k} , {S}_{k} , {ϕ}_{k} ) .$$

Thereafter, the task fusion module may aggregate task-allocated entities corresponding to the object entity

$${E}_{k}^{obj} ,$$

and determine a vector important for the task.

In more detail, the instance segmentation fusion module may group segmented entities having the same label to form a set

$${G}_{label} = \{ \text{?} \vert {L}_{i} = label \} .$$

$$\text{?} \text{indicates text missing or illegible when filed}$$

For each entity of G_{label}, pixels within the mask Mᵢ may be converted into a 3D point cloud Qᵢ using a back-projection process. In this process, a 3D location of a pixel can be generated by integrating a pixel location, depth information, and a camera pose. Q_{label} is defined as the union of Qᵢ of segmented entities having the same label (i.e., Q^{label}=UQᵢ). Close points are highly likely to belong to the same object, and distant points are highly likely to belong to different objects.

The instance segmentation fusion module may perform clustering to classify points and allocate each point to a corresponding object entity. As a result, K_{label} number of object entities may be generated for each label. In the case of the k-th object, the object entity

$${E}_{k}^{obj}$$

has Lₖ=label.

The task fusion module is a process of synthesizing tasks allocated to the same object observed by the robot from various viewpoints. Object images captured from different views include various task-related contexts, so there is significant difficulty in consistently allocating a task to each entity. For example, a close-up image of a stained plate on the floor highlights the features of the stain, making it highly likely to allocate a washing task labeled “wash”. In contrast, an image acquired from a distance generally emphasizes spatial relationships within the environment, thereby allocating a task “relocate”.

The task fusion module may start by aggregating a set of tasks τ allocated to each object. The task fusion module may calculate a task importance vector Øₖ indicating the relative importance of each task through the collected tasks. Each element of the vector

$$\text{?}$$

$$\text{?} \text{indicates text missing or illegible when filed}$$

is calculated through the following formula:

$$\frac{\text{?}}{\vert τ \vert} . \qquad Equation 1$$

$$\text{?} \text{indicates text missing or illegible when filed}$$

Here, l is an indicator function, and Tᵢ is the j-th task of the task set T. The calculated task importance vector Øₖ is used to determine which task the robot should consider preferentially for the corresponding object. These vectors are integrated into the final map M and help the robot to effectively select an object within the environment. Through this process, the robot can consistently and efficiently allocate and suggest a task within a given environment.

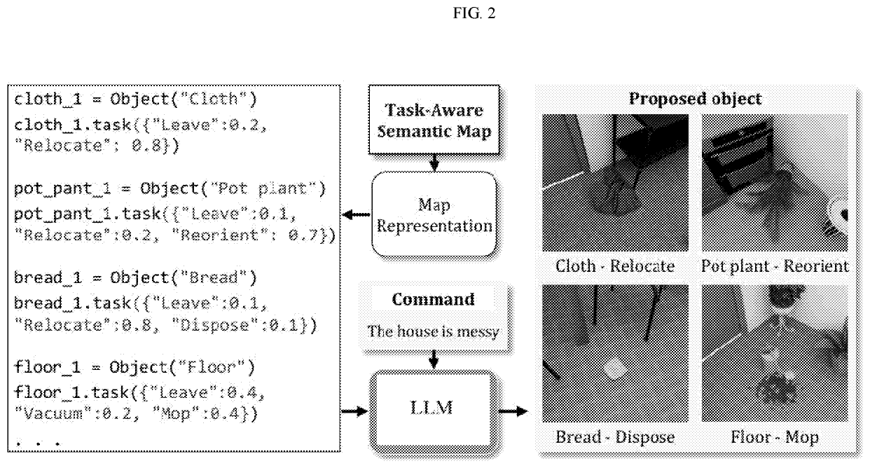

The left diagram of FIG. 2 shows a task-aware semantic map converted into a Python string format. Using the map representation converted into the Python string format and situation information provided in natural language, ‘the house is messy’, an appropriate task can be suggested on the right side. At this time, the situation information may be input as a specific command, or may be recognized using sensor data. In addition, the current situation of the house is input together into one of the large language models, so that an appropriate object is selected. When the situation “the house is messy” is given, it can be confirmed that clothes placed on the floor, a fallen flowerpot, bread on the floor, and a wet floor are selected.

In more detail, the task-aware semantic map building system can select a task without language commands based on situation information or spatial information through the task-aware semantic map. As illustrated in FIG. 2, in a situation where ‘the house is messy’, the task-aware semantic map can suggest tasks such as relocating clothes, reorienting the flowerpot, disposing of the bread, and mopping the room. At this time, if situation information is not provided, the task-aware semantic map building system may recommend cleaning an area that is most affected. In the embodiment, it is assumed that an area having the largest number of tasks related to objects is the most affected. The task-aware semantic map building system can determine a task execution order using a task prioritization method including a context-based task suggestion method and a spatial-based task suggestion method.

The task-aware semantic map building system can suggest a method of selecting an object that the robot should focus on according to a situational context of an environment by utilizing the task-aware semantic map. Here, the context refers to indirect information that can be acquired through sensors or situation data, rather than a direct command. As shown in FIG. 2, the situation information can be expressed in natural language such as ‘the house is messy’.

Task information of the task-aware semantic map can be converted into a Python map representation having two structures. First, label information of an object can be defined as cloth_1=object(‘Cloth’). Then, a task importance vector may be allocated to the object in a format such as cloth_1.task(‘Leave’: 0.2, ‘Relocate’: 0.8). Such a map representation and a situational context may be combined and input to a Vision-Language Model to select a relevant object.

The task-aware semantic map building system can utilize spatial information of the task-aware semantic map to identify a main region having the largest number of tasks. Here, task suggestion is performed on remaining objects excluding objects to which a Leave task is allocated. The task-aware semantic map building system can apply Mean-Shift clustering to spatial information in a set of remaining objects to determine an important group. A central object representing each group can be selected based on proximity to a center of a cluster. Then, task execution priority can be designated according to the number of tasks included in each group.

The task-aware semantic map according to the embodiment of the present invention may be expressed as a set of a plurality of object entities, and each object entity may be defined as a data structure integrally expressing semantic information, spatial information, and task information of an object. For example, each object entity may be expressed in a tuple structure including an object label, a 3D point cloud set corresponding to the object, and a task importance vector. Such a tuple-based data structure can integrate semantic information, spatial information, and action information of an object into a single structured expression, allowing the robot system to perform object recognition, task inference, and task execution planning based on consistent data representation.

In addition, the task-aware semantic map can be converted into a structured map representation including a task importance vector for each object, for example, a Python-based map representation as follows: cloth_1=object(‘Cloth’), cloth_1.task(‘Leave’: 0.2, ‘Relocate’:0.8). Such a structured representation can be combined with a natural language-based prompt and used as an input of a multi-modal large language model, and supports the model to more efficiently infer a relationship between an object and a task. In particular, the task importance vector expresses the relative importance of a plurality of task candidates in the form of a vector, thereby allowing the robot system to efficiently compare and select various task candidates. Such a vector-based representation provides an effect of improving inference efficiency by providing structural consistency of input data in a process in which a multi-modal model infers a relationship between an object state and a task. The task-aware semantic map of the present invention provides an object-centric structured data representation, thereby allowing a multi-modal large language model to integrally infer an object state, spatial information, and task information, serving as an interface.

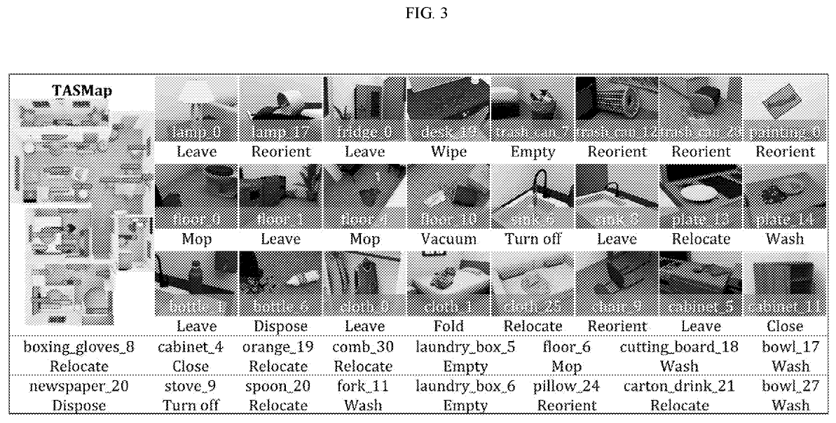

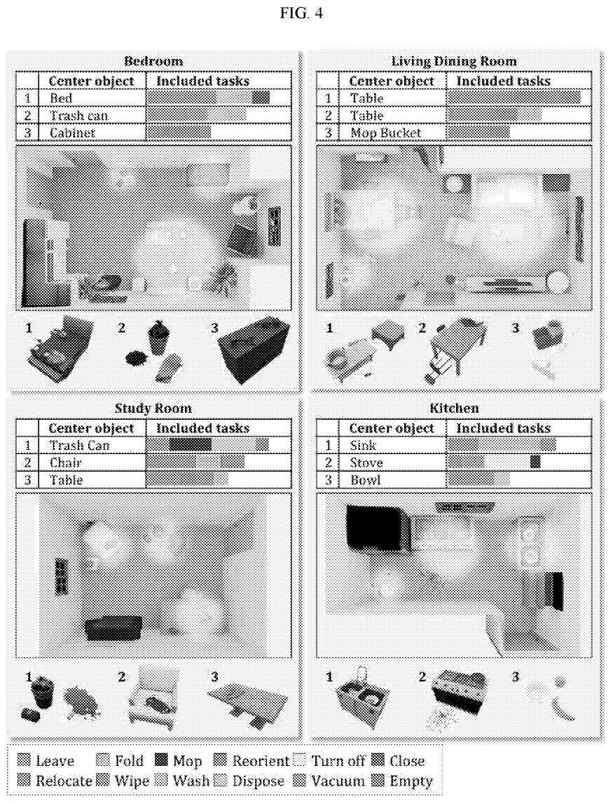

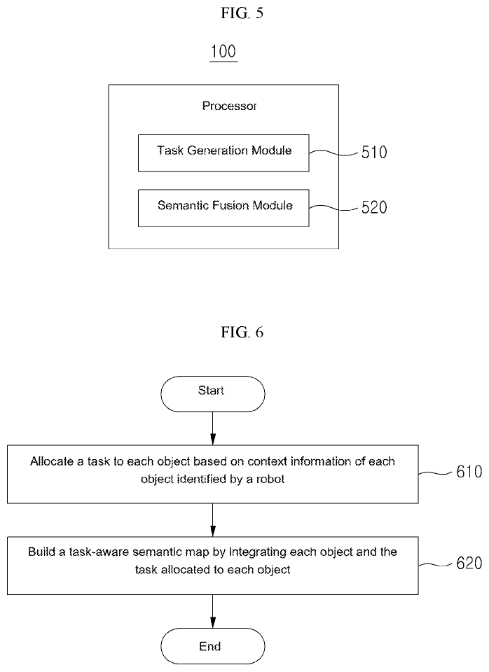

FIG. 3 shows an object entity in which an object name and a main task used for context-based task suggestion are selected. For example, an upright lamp is predicted as ‘Leave’, whereas a ‘Reorient’ task may be suggested for a fallen lamp. When liquid is spilled on a desk, a ‘Wipe’ task is predicted, and a clean desk may be classified as ‘Leave’. When water is running in a sink, a ‘Turn off’ task may be predicted. Clothes in a closet are classified as ‘Leave’, but ‘Relocate’ and ‘Fold’ tasks may be allocated to crumpled clothes on a sofa and a bed, respectively.

The spatial-based task suggestion method designates priorities to a specific object and a region around the object. The top three clusters having the highest priorities and their corresponding task distributions are displayed. Objects forming a cluster may be displayed numbered according to priority. For example, a bed is given first priority in a bedroom, and a task may be arranged together with surrounding objects. According to the task distribution, ‘Relocate’, ‘Wipe’, ‘Fold’, and ‘Dispose’ tasks should be mainly executed in this region. The next priority is a trash can, and a task may be arranged together with two other objects. This cluster indicates that ‘Empty’, ‘Dispose’, and ‘Vacuum’ tasks are required. Such cluster priorities generate an order of regions that the robot should visit first. Consequently, it is possible to suggest where and what tasks the robot should perform even without explicit commands or context information.

A processor of the task-aware semantic map building system 100 may include a task generation module 510 and a semantic fusion module 520. These components of the processor may be representations of different functions performed by the processor according to a control command provided by a program code stored in the task-aware semantic map building system. The processor and the components of the processor may control the task-aware semantic map building system that performs steps 610 to 620 included in the method for building a task-aware semantic map of FIG. 6. At this time, the processor and the components of the processor may be implemented to execute an instruction according to an operating system code and at least one program code included in a memory. The processor may load a program code stored in a file of a program for the task-aware semantic map building method into the memory. For example, when the program is executed in the task-aware semantic map building system, the processor may control the task-aware semantic map building system to load the program code from the file of the program into the memory under the control of the operating system. At this time, the processor may be different functional representations of the processor for executing subsequent steps 610 to 620 by executing instructions of corresponding parts of the program codes loaded into the memory for the task generation module 510 and the semantic fusion module 520, respectively.

In step 610, the task generation module 510 may allocate a task based on context information of each object identified by the robot. The task generation module 510 may receive images of a specific environment captured from different viewpoints or from different positions and directions. The task generation module 510 may detect each object from the received image of the specific environment, and allocate a mask, a label, and a bounding box for each detected object. The task generation module 510 may select a region of interest of each detected object by applying a specific selection criterion. The task generation module 510 may allocate a specific task to an object in the selected region of interest. The task generation module 510 may predict a task to be allocated to the object in the selected region of interest using a multi-modal large language model, and allocate the predicted task to the object in the selected region of interest.

In step 620, the semantic fusion module 520 may integrate each object and the task allocated to each object to build the task-aware semantic map. The semantic fusion module 520 may integrate segmented entities having the same label into an object entity. The semantic fusion module 520 may generate a 3-dimensional (3D) point cloud during the process of integrating into the object entity. The semantic fusion module 520 may perform clustering on the generated 3D point cloud. The semantic fusion module 520 may collect tasks allocated to the same object, and calculate a task importance vector indicating a relative importance of each task through the collected tasks allocated to each object. The semantic fusion module 520 may visualize a result of the calculated task importance vector as a bar graph on the built task-aware semantic map.

According to an embodiment of the present invention, the object entity and the task importance vector included in the task-aware semantic map may be transmitted to a task execution module of the robot. The task execution module may select a task with a high priority based on the task importance vector, and plan a physical operation of the robot using location information of an object corresponding to the selected task. For example, the 3D point cloud or spatial coordinates corresponding to the object entity may be transmitted to a path planning module of the robot to be used to calculate a movement path of a robot platform or an approach path of a robot manipulator. In addition, the task execution module may generate a control signal for controlling hardware components of the robot according to the selected task type. For example, when the task type is “Relocate”, a control signal for picking up and moving the object may be generated by calculating a joint trajectory of the robot manipulator, and when the task type is “Vacuum”, a driving motor of the mobile platform and a driving motor of a cleaning device may be controlled to clean the corresponding area.

Furthermore, the robot system can monitor a task execution state using a sensor such as a camera, a depth sensor, or a force sensor during a task execution process, and can correct an operation of the manipulator or the mobile platform using feedback information acquired from the sensor. Such sensor feedback-based control is performed in connection with the task-aware semantic map, through which the robot can stably perform tasks in an actual environment. Therefore, the task-aware semantic map of the present invention is not a simple data structure but is used as decision-making information for controlling a physical actuator of the robot, through which the robot can perform physical tasks such as moving, organizing, or cleaning objects in an actual physical environment. The system of the present invention generates a control signal for controlling physical actuators such as a driving motor, a manipulator, and a cleaning device of the robot using the task-aware semantic map, through which the robot performs physical tasks of moving, organizing, or cleaning objects in an actual environment.

The apparatus described above may be implemented as hardware components, software components, and/or a combination of hardware components and software components. For example, the apparatus and components described in the embodiments may be implemented using one or more general-purpose computers or special-purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may run an operating system (OS) and one or more software applications running on the operating system. In addition, the processing device may access, store, manipulate, process, and generate data in response to the execution of the software. For convenience of understanding, the processing device is sometimes described as being used as a single device, but those skilled in the art will recognize that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, an instruction, or a combination of one or more of these, and may configure the processing device to operate as desired or command the processing device independently or collectively. The software and/or data may be embodied in any type of machine, component, physical device, virtual equipment, or computer storage medium or device to be interpreted by the processing device or to provide an instruction or data to the processing device. The software may be distributed over networked computer systems so that it is stored and executed in a distributed manner. The software and data may be stored on one or more computer-readable recording media.

The method according to the embodiment may be implemented in the form of program instructions that can be executed through various computer means and recorded on a computer-readable medium. The computer-readable medium may include program instructions, data files, data structures, and the like alone or in combination. The program instructions recorded on the medium may be those specially designed and constructed for the embodiment, or they may be of the kind well-known and available to those having skill in the computer software arts. Examples of computer-readable recording media include magnetic media such as hard disks, floppy disks, and magnetic tapes, optical media such as CD-ROMs and DVDs, magneto-optical media such as floptical disks, and hardware devices specially configured to store and execute program instructions, such as ROMs, flash memories, and the like. Examples of program instructions include not only machine language code such as that generated by a compiler but also high-level language code that can be executed by a computer using an interpreter or the like.

As described above, although the embodiments have been described by the limited embodiments and drawings, various modifications and variations are possible to those skilled in the art from the above description. For example, appropriate results may be achieved even if the described techniques are performed in a different order from the described method, and/or components of the described system, structure, apparatus, circuit, etc. are coupled or combined in a different form from the described method, or replaced or substituted by other components or equivalents. Therefore, other implementations, other embodiments, and equivalents to the claims are also within the scope of the following claims.

What is claimed is:

1. A method for building a task-aware semantic map performed by a task-aware semantic map building system, the method comprising: allocating a task to each object based on context information of each object identified by a robot; and building the task-aware semantic map by integrating said each object and the task allocated to said each object.

2. The method of claim 1, wherein the allocating of the task comprises: receiving images of a specific environment captured from different viewpoints or from different positions and directions.

3. The method of claim 2, wherein the allocating of the task comprises: detecting each object from the received image of the specific environment, and allocating a mask, a label, and a bounding box to each detected object, and wherein said each object is defined as a segmented entity.

4. The method of claim 3, wherein the allocating of the task comprises: selecting a region of interest of each detected object by applying a specific selection criterion, and wherein the specific selection criterion includes at least one of a criterion for excluding a bounding box intersecting with an image boundary or a criterion for excluding a bounding box having a preset size or less.

5. The method of claim 4, wherein the allocating of the task comprises: allocating a specific task to an object in the selected region of interest.

6. The method of claim 5, wherein the allocating of the task comprises: predicting a task to be allocated to the object in the selected region of interest using a multi-modal large language model, and allocating the predicted task to the object in the selected region of interest, and wherein information input to the multi-modal large language model includes an object image corresponding to the selected region of interest, label information of the object, and context information on a surrounding environment of the object.

7. The method of claim 1, wherein the building of the task-aware semantic map comprises: integrating segmented entities having the same label into an object entity.

8. The method of claim 7, wherein the building of the task-aware semantic map comprises: generating a 3-dimensional (3D) point cloud during the process of integrating into the object entity.

9. The method of claim 8, wherein the building of the task-aware semantic map comprises: performing clustering on the generated 3D point cloud.

10. The method of claim 9, wherein the building of the task-aware semantic map comprises: identifying each object according to performing the clustering, and wherein each identified object is defined as a set of 3D point clouds having a close distance and a similar label.

11. The method of claim 1, wherein the building of the task-aware semantic map comprises: collecting tasks allocated to the same object, and calculating a task importance vector indicating a relative importance of each task through the collected tasks allocated to each object.

12. The method of claim 11, wherein the calculated task importance vector determines a priority of a task to be processed by the robot for the corresponding object.

13. The method of claim 12, wherein the building of the task-aware semantic map comprises: visualizing a result of the calculated task importance vector in a graphic form on the built task-aware semantic map.

14. The method of claim 6, wherein the image input to the multi-modal large language model is generated by cropping an object region around the bounding box and including a preset pixel margin around the bounding box.

15. The method of claim 6, wherein the prompt input to the multi-modal large language model includes one or more few-shot examples explaining a relationship between an object state and a corresponding task.

16. The method of claim 11, wherein the task importance vector is expressed in a vector form including values indicating a relative importance for each of a plurality of candidate tasks.

17. The method of claim 7, wherein the object entity is expressed as a data structure in a tuple form including an object label, a set of 3D point clouds corresponding to the object, and the task importance vector.

18. The method of claim 1, wherein the task-aware semantic map is converted into a structured map representation including task importance for each object.

19. The method of claim 18, wherein the structured map representation is expressed as a data structure including an object label and a task importance vector.

20. A task-aware semantic map building system comprising: a task generation module configured to allocate a task to each object based on context information of each object identified by a robot; and a semantic fusion module configured to build the task-aware semantic map by integrating said each object and the task allocated to said each object.
